(19) United States
(12) Patent Application Publication
(10) Pub. No.: US 2024/0306596 A1
(43) Pub. Date: Sep. 19, 2024

(54) CONVERTIBLE DOG CARRYING BACKPACK AND LAPTOP BAG

(71) Applicant: K9 Sport Sack LLC, Lehi, UT (US)

(72) Inventors: Tyler J. Egbert, Lehi, UT (US); Joseph Watson, Lehi, UT (US); Spencer Kottcamp, Lehi, UT (US)

(21) Appl. No.: 18/185,306

(22) Filed: Mar. 16, 2023

(51) Int. Cl. A01K 1/02; A45F 3/04

(52) U.S. Cl. CPC A01K 1/029; A45F 3/04; A45F 2200/0525

(57) ABSTRACT

A convertible pet carrying and laptop backpack can include a backpack body having a top opening to accommodate a head of a pet to protrude therethrough. The backpack can have shoulder straps configured to be worn over the shoulders of a user, a pair of paw holes disposed above the shoulder straps and below the top opening, an attachment clip disposed above each paw hole, and a pair of webbing straps disposed on the rear side of the backpack body. The top opening can be selectively closeable by folding a top portion of the backpack body and attaching the attachment clip to the webbing strap on the rear side of the backpack body. The pair of paw holes can be aligned with the pair of webbing straps when the top portion is folded and attached to the rear side of the backpack body.

### TECHNICAL FIELD

This disclosure relates generally to backpacks. More specifically, the disclosure relates to backpacks for carrying pets that can also have other uses.

### BACKGROUND

Many people enjoy keeping pets for the companionship, help, and/or friendship that they provide. Pets, of course, require substantial time and attention from their owners to ensure that they are well cared for. Sometimes, pet owners would like to travel, hike, or participate other activities which their pets are not capable of due to the pet's size, age, or various health issues. Many pet owners also prefer not to leave their pets in the care of friends or commercial pet care facilities while participating in such activities. Accordingly, such pet owners are need of a solution that allows them to participate in activities they find enjoyable while being able to bring along their pet companions that may not otherwise be capable of joining with them.

### SUMMARY

According to some examples of the disclosure, a convertible pet carrying and laptop backpack can comprise a backpack body that defines an interior. The backpack body can have a top opening being that can be configured to accommodate a head of a pet to protrude therethrough and that can be configured to be selectively closeable. The backpack can further comprise shoulder straps extending from a front side of the backpack body. The shoulder straps can be configured to be worn over the shoulders of a user.

The backpack can further comprise a pair of paw holes disposed above the shoulder straps and below the top opening. Each of the paw holes can be configured to accommodate a paw of the pet to protrude therethrough. The backpack can also comprise an attachment clip disposed above each paw hole and a pair of webbing straps disposed on the rear side of the backpack body.

The top opening can be selectively closeable by folding a top portion of the backpack body and attaching the attachment clip to the webbing strap on the rear side of the backpack body. The pair of paw holes can be aligned with the pair of webbing straps when the top portion is folded and attached to the rear side of the backpack body.

In some examples, each attachment clip can comprise a G-clip. In some examples, the webbing straps can be intermittently attached to the rear side to form loops. The attachment clips can interface with the loops to attach to the pair of webbing straps. Each of the paw holes can comprise a liner, and wherein the width of each liner is similar to a width of each webbing strap.

In some examples, the paw holes can be selectively closeable. In one example, the backpack can comprise a paw hole zipper operable to selectively close each paw hole. In another example, the backpack can comprise a hook and loop fastener operable to selectively close each paw hole.

In another example of the present disclosure, a convertible pet carrying and laptop backpack can comprise a backpack body defining an interior. The backpack body can comprise a top opening that can be configured to accommodate a head of a pet to protrude therethrough and can be configured to be selectively closeable.

The backpack can further comprise shoulder straps extending from a front side of the backpack body. The shoulder straps can be configured to be worn over the shoulders of a user. The backpack can comprise at least one opening disposed above the shoulder straps and below the top opening. The at least one opening can be configured to accommodate a paw or paws of the pet to protrude therethrough. The backpack can also comprise a laptop sleeve disposed within the interior of the backpack body.

In some examples, the top opening can be selectively closeable by folding a top portion of the backpack body and attaching the top portion of the backpack body to a rear side of the backpack body. In some examples, the at least one opening can comprise a pair of paw holes disposed on the front side of the backpack body. The convertible pet carrying backpack can further comprise a pair of webbing straps disposed on the rear side of the backpack body. The pair of paw holes can be aligned with the pair of webbing straps when the top portion is folded and attached to the rear side of the backpack body.

In some examples, the backpack can comprise a pair of G-clips disposed above the shoulder straps. The pair of G-clips can be configured to attach to the pair of webbing straps when the top portion is folded and attached to the rear side of the backpack body. The webbing straps can be intermittently attached to the rear side at various locations to form loops. The G-clips can interface with the loops to attach to the pair of webbing straps. In some examples, the backpack can comprise contouring straps operable to extend through the loops of the webbing straps. In some examples, each of the paw holes comprises a liner. The width of each liner can be similar to a width of each webbing strap.

In some examples, the at least one opening can be selectively closeable. For example, the backpack can comprise a paw hole zipper operable to selectively close the at least one opening. In another example, the backpack can comprise a hook and loop fastener operable to selectively close the at least one opening.

In some examples, the backpack can comprise a zipper that extends vertically along or near a side of the backpack and that extends up and over a top of the backpack to selectively close the top opening. In one example, the backpack can comprise a front flap. The front flap can comprise the at least one opening accommodating the paw or paws of the pet. The front flap can be operable to extend above the zipper when the backpack is used to carry a pet, and to retract below the zipper when the backpack is not used to carry a pet. In one examples, the backpack can comprise a rear flap. The rear flap can be operable to extend above the zipper when the backpack is used to carry a pet, to retract below the zipper when the backpack is not used to carry a pet, and to attach to the front flap when the backpack is used to carry a pet such that the front flap and the rear flap extend around a neck of the pet.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIG. 1 is an isometric view of a convertible pet carrying backpack and laptop bag according to the present disclosure;

FIG. 2 is a rear view of the convertible pet carrying backpack and laptop bag shown in FIG. 1;

FIG. 3 is a side view of the convertible pet carrying backpack and laptop bag shown in FIG. 1;

FIG. 4 is a front view of the convertible pet carrying backpack and laptop bag shown in FIG. 1 with a top portion folded over;

FIG. 5 is a top isometric view of the convertible pet carrying backpack and laptop bag shown in FIG. 1;

FIG. 6 is an enlarged view of a top portion of the convertible pet carrying backpack and laptop bag shown in FIG. 1;

FIG. 7 is an enlarged view of a top portion of the convertible pet carrying backpack and laptop bag shown in FIG. 1; and

FIG. 8A is a isometric view of a convertible pet carrying backpack and laptop bag with a top portion folded within a top opening; and FIG. 8B is the convertible pet carrying backpack and laptop bag of FIG. 8A with the top portion unfolded.

### DETAILED DESCRIPTION

The illustrations presented herein are not actual views of any convertible dog carrying backpack and laptop bag, or any component thereof, but are merely idealized representations, which are employed to describe embodiments of the present invention.

As used herein, the singular forms following “a,” “an,” and “the” are intended to include the plural forms as well, unless the context clearly indicates otherwise.

As used herein, the term “can” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any backpack when utilized in a conventional manner. Furthermore, these terms may refer to an orientation of elements of any backpack as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

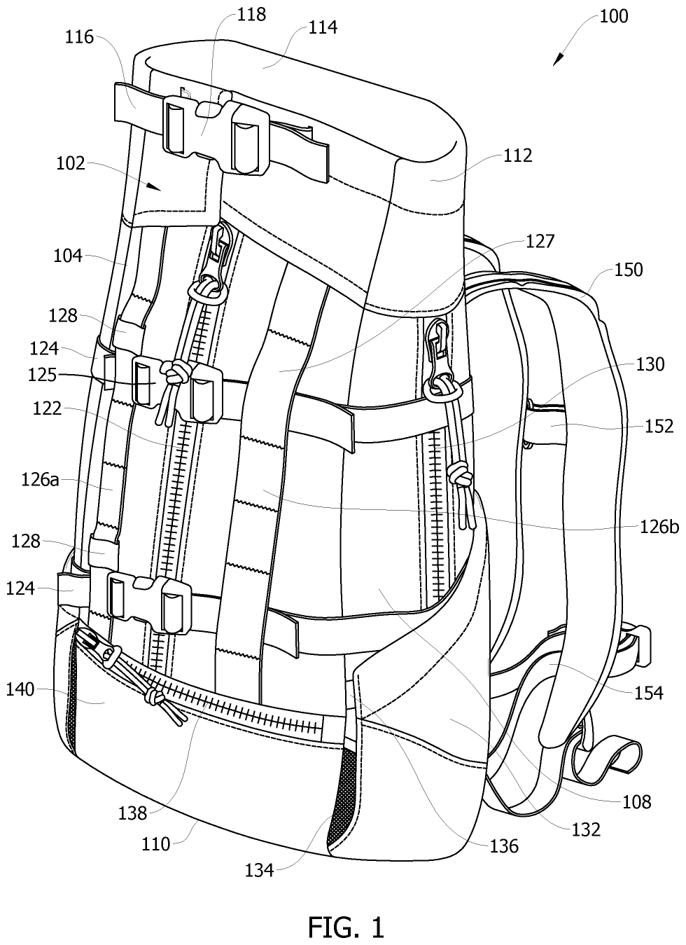

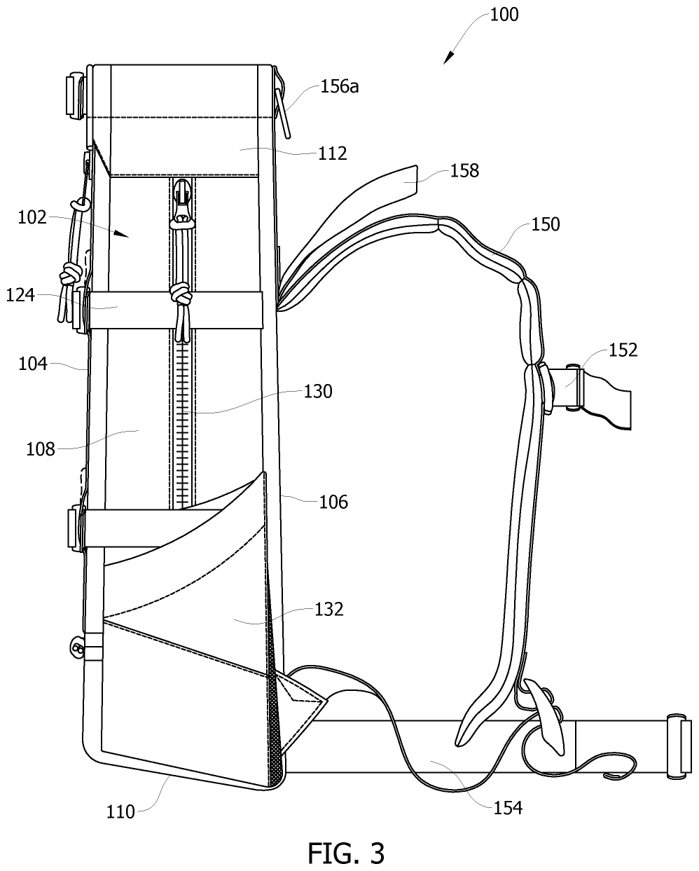

A convertible pet carrying backpack and laptop bag 100 (hereinafter “backpack”) is shown in FIGS. 1-3. The backpack 100 can be operable to carry a pet therein such that the pet sits in the backpack 100 facing forward, i.e., in the same direction the wearer of the backpack faces. The backpack 100 can comprise a backpack body 102 that defines an interior of the backpack 100. The backpack body 102 can be formed in any suitable manner such as by joining together one or more panels of fabric via stitching, fabric welding, or the like. In this example, the backpack body 102 can comprise a rear panel 104, a front panel 106, side panels 108 that attach and are joined to the rear panel 104 and the front panel 106, and a rear panel 104 that attaches and joins to the front panel 106, side panels 108, and rear panels 104. The backpack body 102 can be formed to be any suitable size based upon a size of a pet to be carried.

The bottom panel 110 can house or support a pet carrying platform. The pet carrying platform can provide a surface on which the pet can sit while being carrying the backpack 100. The pet carrying platform can comprise a frame member such as a structural planar member supported on or within the bottom panel 110. For example, the frame member can comprise a planar plastic member or other member comprising any other suitable material. The pet carrying platform can also comprise a padded member such as a foam pad to provide comfort to the pet riding within the backpack 100.

The backpack 100 can comprise shoulder straps 150 that extend from the front panel 106 of the backpack body 102. The backpack body 102 can comprise a top portion 112 that extends above the shoulder straps 150. The top portion 112 can define a top opening 114 through which the pet's head can extend while riding in the backpack 100. The top portion 112 can also comprise a collar strap 116 that can adjust the size of the top opening 114 via a buckle 118.

The top portion 112 can further comprise one or more openings 120 in the front panel 106 above the shoulder straps 150 and below the collar strap 116. In this example, the one or more openings comprise a first paw hole 120a and a second paw hole 120b that allow the pet's paws to extend through the front panel 106. In this manner, the pet's paws can rest on the shoulders/back of the user wearing the backpack 100. Furthermore, the first and second paw holes 120a, 120b can help to stabilize and secure the pet within the backpack 100. However, this is not intended to be limiting. In some examples, a single, larger opening 120 can be utilized through which both paws can extend through the front panel 106 to rest on the back or shoulder of the user wearing the backpack 100. In some examples, the opening 120 can be formed by removing part of the front panel 106 in the area of top portion 112 such that the opening 120 for the pet's paws extend from the shoulder straps 150 to the collar strap 116 between the side panels 108.

The rear panel 104 can comprise a vertical zipper 122 that facilitates the loading and unloading of the pet to and from the backpack 100. The vertical zipper 122 can be aligned with the buckle 118 of the collar strap on the rear panel such that when the buckle 118 is unfastened and vertical zipper 122 is opened, the rear panel can be separated from the top opening 114. While a single vertical zipper 122 is shown in FIG. 1, there can be multiple vertical zippers, such as a vertical zipper 122 along each side of the rear panel 104 to peel back the rear panel 104 to load/unload the pet instead of separating the rear panel 104.

The backpack 100 can further comprise one or more contouring straps 124. The contouring straps 124 can extend around at least a portion of the backpack body 102 to shape the backpack body 102 and support a pet therein. The contouring straps 124 can be configured to cross over the vertical zipper 122 to add safety by taking stress from the vertical zipper 122 during use. In the example shown in FIGS. 1-3, the contouring straps 124 can extend from a scam between the front panel 106 and the side panels 108 and can extend around the side panels 108 and the rear panel 104. The contouring straps 124 can extend from each side of the backpack body 102 and can be joined together and can be adjusted via buckles 125. In this manner, the contouring straps 124 can adjust the size of the backpack body 102 and can take pressure off of the vertical zipper 122 while a pet or other items are held within the backpack 100.

The backpack 100 can comprise a first webbing strap 126a and a second webbing strap 126b that are disposed on the rear panel 104 and that extend vertically along the rear panel 104 so as to run substantially parallel with the vertical zipper 122. The first and second webbing straps 126a, 126b can be intermittently attached to the rear panel 104 at various locations to form loops 127 formed by portions of the webbing straps 126a, 126b and the rear panel 104. The loops 127 can accommodate the contouring straps 124 to help maintain the contouring straps 124 in a desired position. The loops 127 can also accommodate a hook and loop hoop 128 that can be attached to a loop 127 to facilitate the attachment of one or more accessories to the backpack 100, such as an embroidered patch or the like. As will be discussed further below, the loops 127 can also facilitate closing the top opening 114 of the backpack 100 for when the backpack 100 is used for purposes other than carrying pet, such as to carry a laptop or the like.

The side panels 108 can comprise a vent zipper 130 that is selectively openable to allow increased airflow into the interior of the backpack 100. The side panels 108 can further comprise a side pocket 132 that is expandable via an elastic strap 136 that is disposed within a top portion of the side pocket 132 and flexible webbing 134 disposed at a seam between the rear panel 104 and the side panels 108.

The backpack 100 can also comprise a pocket access zipper 138 disposed at the bottom of the vertical zipper 122 and configured to run substantially perpendicular to the vertical zipper. The pocket access zipper 138 can provide access to a rear accessory pocket 140. The rear accessory pocket 140 can accommodate small personal items such that they can be easily accessible. Such small personal items might include keys or a cell phone. The rear accessory pocket 140 could also accommodate small pet supplies such as a leash, plastic pet waste bags, or the like.

As mentioned above, the backpack 100 can comprise shoulder straps 150 extending from the front panel 106 of the backpack body 102. The backpack can further comprise a sternum strap 152 that can be fastened across the user's sternum while wearing the backpack to add stability. A waist strap 154 can also be provided to allow the user to bear a portion of the weight on the backpack 100 on the user's hips. A hand-carry strap 158 can also be provided to allow a user to hold and carry the backpack 100 in an upright position.

The backpack 100 can be configured to serve multiple purposes. For example, the backpack 100 can be configured to carry a pet therein. To this end, a user can disengage the buckle 118 of the collar strap 116 and open the vertical zipper 122 to load a pet into the backpack 100. For example, the pet can sit or lay down in the interior of the backpack 100 while the buckle 118 is disengaged and the vertical zipper 122 is open. The pet's paws can be led through the paw holes 120a, 120b. The vertical zipper 122 can then be closed around the pet and the buckle 118 can be engaged such the collar strap 116 extends around the pet's neck. The contouring straps 124 can be tightened around the backpack body 102 such that the backpack body 102 supports the pet and the contouring straps 124 can take at least part of load or stress off of the vertical zipper.

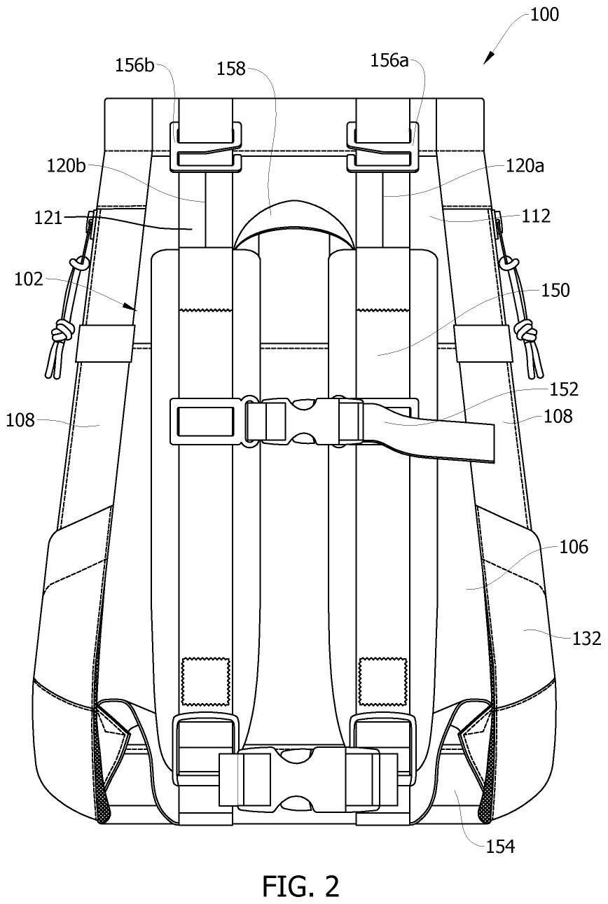

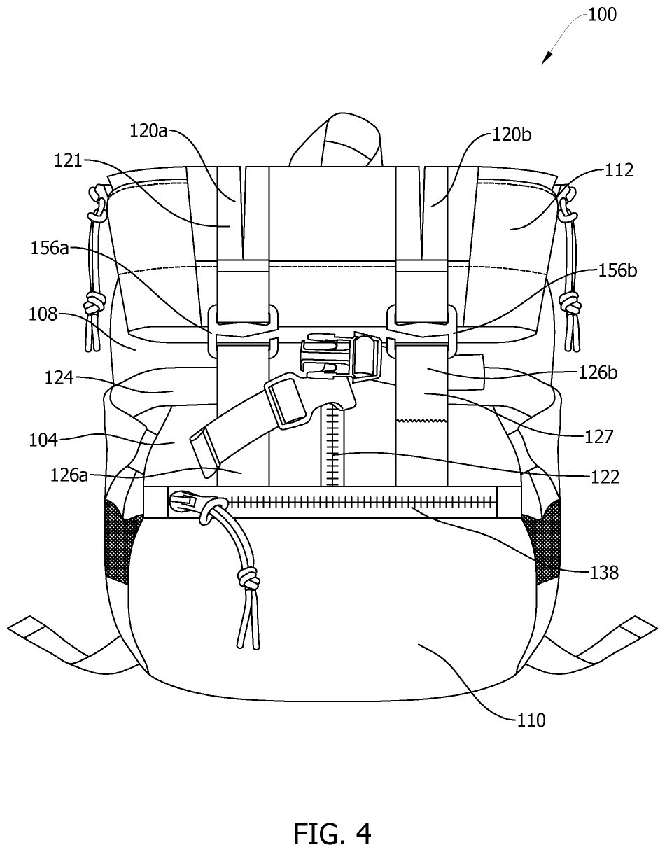

In other examples, a user may wish to use the backpack 100 for other purposes outside of carrying the pet. To this end, the backpack 100 can comprise additional features to allow the backpack to carry other items, such as a laptop, books, or other various personal items. As shown in FIGS. 2-4, the backpack 100 can comprise a first attachment clip 156a and a second attachment clip 156b. The first attachment clip 156a can comprise a G-clip and can be attached to the backpack 100 on the top portion 112 above the first paw hole 120a. Similarly, the second attachment clip 156b can comprise a G-clip and can be attached to the backpack 100 on the top portion 112 above the second paw hole 120b. While in this example, the first and second attachment clips 156a, 156b are shown as G-clips, any other suitable attachment device could be used such as a spring clip, a buckle, a hook, etc.

The first and second attachment clips 156a, 156b can be operable to close the top opening 114 of the backpack 100 when the backpack is used to carry other items instead of a pet. The top opening 114 can be operable to fold towards the rear panel 104 such that the first and second attachment clips 156a, 156b can connect to loops 127 of the first and second webbing straps 126a, 126b, respectively. With the first and second attachment clips 156a, 156b attached to the first and second webbing straps 126a, 126b, respectively, the top opening 114 of the backpack 100 is closed, and thus items within the backpack 100 can be more safely retained.

To facilitate a uniform look and ease of use, the first paw hole 120a can be aligned with the first attachment clip 156a and the first webbing strap 156a. Similarly, the second paw hole 120b can be aligned with the second attachment clip 156b and the second webbing strap 126b. By aligned, it is meant that the first and second attachment clips 156a, 156b, the first and second paw holes 120a, 120b, and the first and second webbing straps 126a, 126b are substantially the same distance from the side panels 108 or from the vertical zipper 122. Thus, when the top portion 112 is folded over, and when the first and second attachment clips 156a, 156b are attached to the first and second webbing straps 126a, 126b, respectively, the paw holes align seamlessly with the webbing straps. This can maintain a uniform look for the backpack 100 when carrying items other than a pet, even though the backpack 100 includes the paw holes 120a, 120b. Furthermore, the first and second paw holes 120a, 120b can each comprise lining 121 that can be made to have a width similar to the width of the webbing straps 126a, 126b, further adding to the uniformity of the look of the backpack 100.

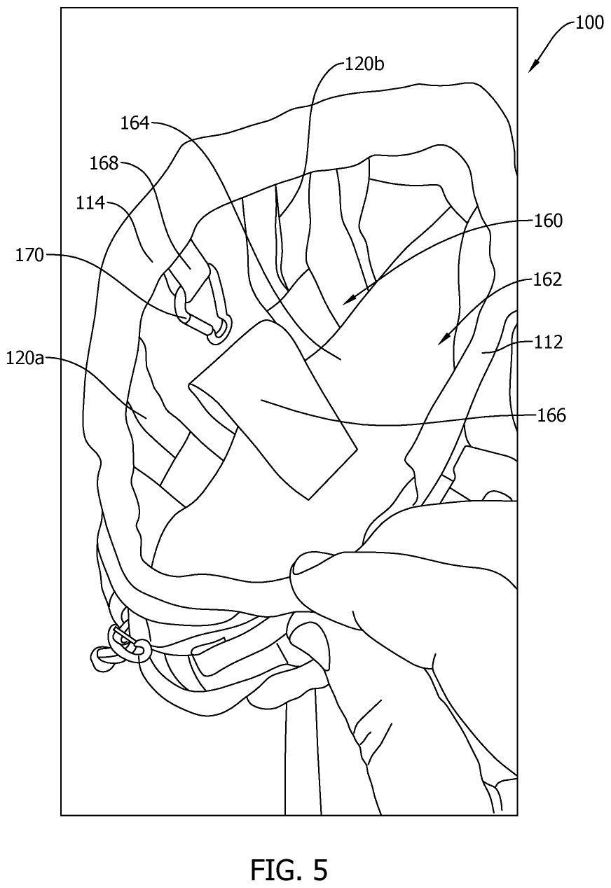

FIG. 5 shows an example of an interior of the backpack 100. In FIG. 5, an interior of the backpack from the top opening 114 is shown. The interior can comprise a laptop compartment 160 and a main compartment 162 separated by a laptop sleeve 164. In addition to protecting a laptop when inserted into the laptop compartment 160, the laptop sleeve 164 can provide additional padding for a pet when the backpack 100 is used in the pet configuration with the pet sitting in the main compartment 162. The interior of the backpack 100 can further comprise a laptop strap 166 that partially closes the laptop compartment 160 to hold a laptop or other item securely in the laptop compartment 160. The interior can also comprise a carabiner loop 168 that can support a clip 170 such as a carabiner which can attach to a pet's collar to further secure the pet within the backpack 100. Additional carabiner loops can be placed at other locations on the interior of the backpack, such as to attach to various portions of a harness worn by a pet held within the backpack 100.

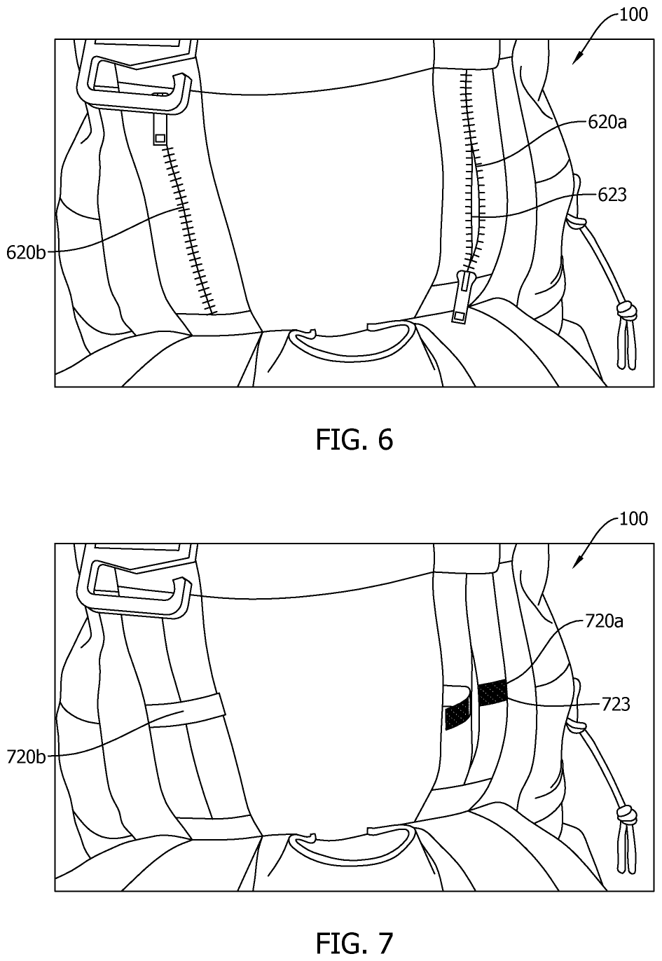

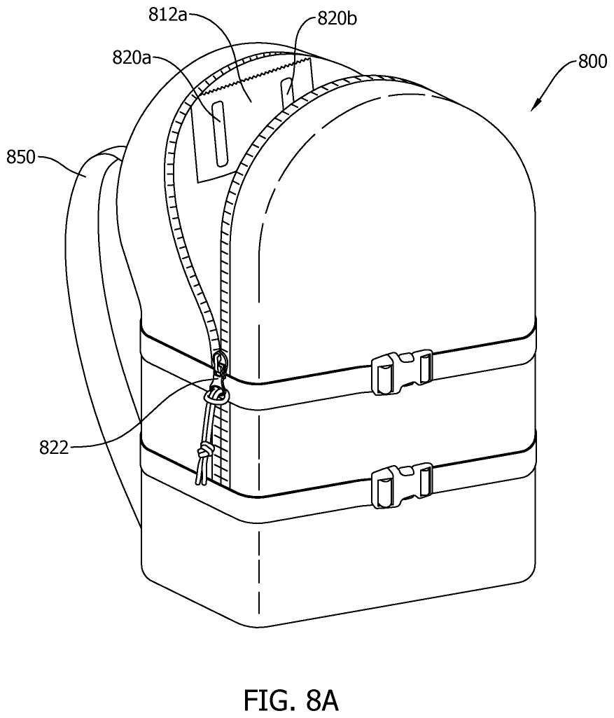

In some examples, when the backpack 100 is used for purposes other than carrying a pet, the paw holes can be operable to be closeable. In FIG. 6, the backpack 100 can comprise a first paw hole 620a and a second paw hole 620b. The first and second paw holes 620a, 620b can be closeable via a paw hole zipper 623. In FIG. 7, the backpack 100 can comprise a first paw hole 720a and a second paw hole 720b. The first and second paw holes 720a, 720b can be closeable via hook and loop fasteners 723. It is noted that while the hook and loop fasteners 723 shown in FIG. 7 extend along only a portion of the paw holes 720a, 720b, the hook and loop fasteners 723 could extend along the entire length of the paw holes 720a, 720b. Further, there could be multiple hook and loop fasteners 723 along the length of the paw holes 720a, 720b.

In the above example, the top portion 112 of the backpack 100 is foldable to close the top opening 114 such that the backpack 100 can be used for other purposes besides carrying a pet. However, this example is not intended to be limiting. There can be a variety of ways to convert a pet carrying backpack to a laptop bag or other bag type.

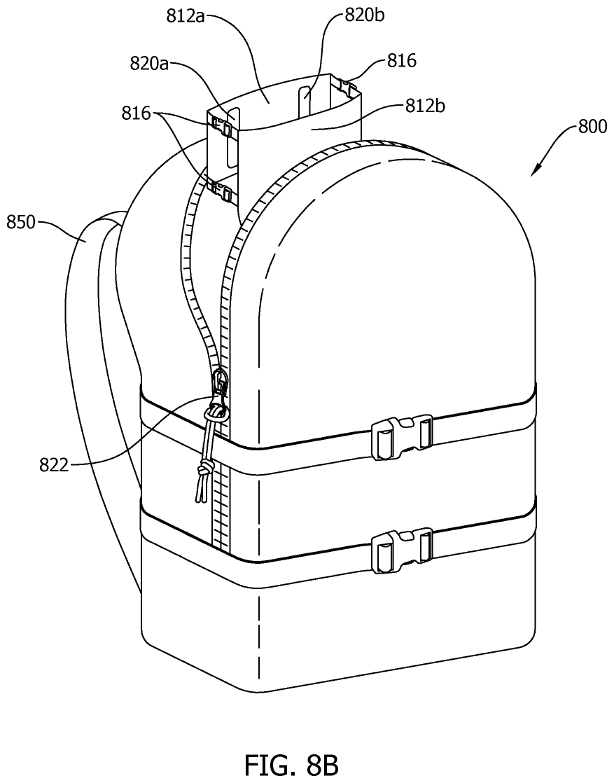

FIG. 8A shows a convertible pet carrying backpack and laptop bag with a top portion folded within a top opening, and FIG. 8B shows the convertible pet carrying backpack and laptop bag of FIG. 8A with the top portion unfolded. As shown in FIGS. 8A and 8B, a convertible pet carrying backpack and laptop bag (“backpack”) 800 can comprise a zipper 822 that extends vertically along or near a side of the backpack 800 and extends up and over a top of the backpack 800 similar to many existing backpacks. The zipper 822 can selectively close or allow access into an interior of the backpack 800 similar to other existing backpacks.

The backpack 800 can comprise a front flap 812a and a rear flap 812b that are operable to be folded within the backpack 800 as shown in FIG. 8A when the backpack 800 is not used for carrying a pet. When a user desires to use the backpack 800 for carrying a pet, the front and rear flaps 812a, 812b can be unfolded and extended above the zipper 822 such that paw holes 820a, 820b in the front flap are positioned above the shoulder straps 850. The front and rear flaps 812a, 812b can be connected together and connected around a neck area of the pet via straps 816 joined by buckles. Other methods of connecting the front and rear flaps 812a, 812b could also be used such as zippers, hook and loop fasteners, or the like. The front and rear flaps 812a, 812b can be considered a top portion of the backpack 800. The backpack 800 can include features of the backpack 100 in any desired combination, such as a laptop sleeve and the like. Thus, these features are not explained here for the sake of brevity.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A convertible pet carrying and laptop backpack comprising:
a backpack body defining an interior, the backpack body comprising a top opening being configured to accommodate a head of a pet to protrude therethrough and being configured to be selectively closeable;
shoulder straps extending from a front side of the backpack body, the shoulder straps being configured to be worn over the shoulders of a user;
a pair of paw holes disposed above the shoulder straps and below the top opening, each of the paw holes being configured to accommodate a paw of the pet to protrude therethrough;
an attachment clip disposed above each paw hole; and
a pair of webbing straps disposed on the rear side of the backpack body,
wherein the top opening is selectively closeable by folding a top portion of the backpack body and attaching the attachment clip to the webbing strap on the rear side of the backpack body, and
wherein the pair of paw holes are aligned with the pair of webbing straps when the top portion is folded and attached to the rear side of the backpack body.

2. The backpack of claim 1, wherein each attachment clip comprises a G-clip.

3. The backpack of claim 1, wherein the webbing straps are intermittently attached to the rear side to form loops, and wherein the attachment clips interface with the loops to attach to the pair of webbing straps.

4. The backpack of claim 1, wherein each of the paw holes comprises a liner, and wherein the width of each liner is similar to a width of each webbing strap.

5. The backpack of claim 1, wherein the paw holes are selectively closeable.

6. The backpack of claim 5, further comprising a paw hole zipper operable to selectively close each paw hole.

7. The backpack of claim 5, further comprising a hook and loop fastener operable to selectively close each paw hole.

8. A convertible pet carrying and laptop backpack comprising:
a backpack body defining an interior, the backpack body comprising a top opening being configured to accommodate a head of a pet to protrude therethrough and being configured to be selectively closeable;
shoulder straps extending from a front side of the backpack body, the shoulder straps being configured to be worn over the shoulders of a user;
at least one opening disposed above the shoulder straps and below the top opening, the at least one opening being configured to accommodate a paw or paws of the pet to protrude therethrough; and
a laptop sleeve disposed within the interior of the backpack body.

9. The backpack of claim 8, wherein the top opening is selectively closeable by folding a top portion of the backpack body and attaching the top portion of the backpack body to a rear side of the backpack body.

10. The backpack of claim 9, wherein the at least one opening comprises a pair of paw holes disposed on the front side of the backpack body, wherein the convertible pet carrying and laptop backpack further comprises a pair of webbing straps disposed on the rear side of the backpack body, and wherein the pair of paw holes are aligned with the pair of webbing straps when the top portion is folded and attached to the rear side of the backpack body.

11. The backpack of claim 10, further comprising a pair of G-clips disposed above the shoulder straps, the pair of G-clips being configured to attach to the pair of webbing straps when the top portion is folded and attached to the rear side of the backpack body.

12. The backpack of claim 11, wherein the webbing straps are intermittently attached to the rear side at various locations to form loops, and wherein the G-clips interface with the loops to attach to the pair of webbing straps.

13. The backpack of claim 12, further comprising contouring straps operable to extend through the loops of the webbing straps.

14. The backpack of claim 10, wherein each of the paw holes comprises a liner, and wherein a width of each liner is similar to a width of each webbing strap.

15. The backpack of claim 8, wherein the at least one opening is selectively closeable.

16. The backpack of claim 15, further comprising a paw hole zipper operable to selectively close the at least one opening.

17. The backpack of claim 15, further comprising a hook and loop fastener operable to selectively close the at least one opening.

18. The backpack of claim 8, further comprising a zipper that extends vertically along or near a side of the backpack and that extends up and over a top of the backpack to selectively close the top opening.

19. The backpack of claim 18, further comprising a front flap, the front flap comprising the at least one opening accommodating the paw or paws of the pet, the front flap being operable to extend above the zipper when the backpack is used to carry a pet, and to retract below the zipper when the backpack is not used to carry a pet.

20. The backpack of claim 19, further comprising a rear flap, the rear flap being operable to extend above the zipper when the backpack is used to carry a pet, to retract below the zipper when the backpack is not used to carry a pet, and to attach to the front flap when the backpack is used to carry a pet such that the front flap and the rear flap extend around a neck of the pet.
